(19) United States
(12) Patent Application Publication
(10) Pub. No.: US 2026/0316556 A1
(43) Pub. Date: Oct. 15, 2026

(54) FUEL TANK FOR WORK MACHINE

(71) Applicant: Caterpillar Global Mining Equipment LLC., Denison, TX (US)

(72) Inventors: Shamshad S. Ahmed, Oro-Valley, AZ (US); Ankush Sharma, Jalandhar City (IN); Sabyasachi Biswal, Cuttack (IN)

(73) Assignee: Caterpillar Global Mining Equipment LLC., Denison, TX (US)

(21) Appl. No.: 19/178,939

(22) Filed: Apr. 15, 2025

(51) Int. Cl. B60K 15/03

(52) U.S. Cl. CPC B60K 15/03006; B60K 2015/0344

(57) ABSTRACT

A fuel tank for a work machine includes a housing including a first wall, a second wall, a first sidewall, a second sidewall, a top wall, and a bottom wall. The fuel tank also includes at least two first baffles defining a plurality of through-openings proximal to the bottom wall, at least two first cut-outs at a location where the at least two first baffles are coupled with the first wall, and at least two second cut-outs at a location where the at least two first baffles are coupled with the second wall. The fuel tank further includes at least two second baffles defining at least two third cut-outs at a location where the at least two second baffles are coupled with the first wall and at least two fourth cut-outs at a location where the at least two second baffles are coupled with the second wall.

### TECHNICAL FIELD

The present disclosure relates to a work machine, and more particularly, to a fuel tank for the work machine.

### BACKGROUND

A work machine, such as a mining truck, is often used at various worksites to perform work operations. Work machines that are large in size require a large sized power source to power various components of the work machines. The power source requires a large amount of fuel which is stored in one or more fuel tanks of the work machine.

Conventional fuel tanks include internal baffles that extend vertically to prevent fuel from moving excessively, and internal cross supports that extend horizontally across the fuel tank. The internal cross supports intersect and support the internal baffles. In some cases, after manufacturing, sediments such as dirt, dust, fragments, and the like may accumulate at edges or corners formed by the internal cross supports and/or the internal baffles. The sediments may remain trapped in the fuel tank even after a cleaning operation, and may impact a cleanliness of the fuel and the fuel tank, which is not desirable.

CN111775690A describes a fuel tank for a cold regenerator, and belongs to the technical field of cold regenerators. The fuel tank comprises a tank body; an oil filling port, an oil suction port and an oil return port which are formed in the tank body and connected into the tank body in a penetrating mode; and a cleaning channel arranged on the tank body and connected to the interior of the tank body in a penetrating manner. The cleaning channel comprises a first cleaning port formed in the side surface of the tank body, a second cleaning port formed in the lower portion of one side, close to the oil filling port, of the periphery of the tank body, and a third cleaning port formed in the bottom of the tank body. According to the fuel tank for the cold regenerator, the multiple cleaning openings are formed, so that the interior of the fuel tank can be conveniently and rapidly cleaned, and the cleanliness and the cleaning efficiency of the fuel tank are guaranteed.

### SUMMARY OF THE DISCLOSURE

In an aspect of the present disclosure, a fuel tank for a work machine is provided. The fuel tank includes a housing defining a first end and a second end spaced apart from the first end along a longitudinal axis of the housing. The housing includes a first wall disposed at the first end of the housing. The housing also includes a second wall disposed at the second end of the housing. The housing further includes a first sidewall extending between the first wall and the second wall. The housing includes a second sidewall extending between the first wall and the second wall. The second sidewall is spaced apart from the first sidewall along a lateral axis of the housing. The housing also includes a top wall extending between the first wall and the second wall. The housing further includes a bottom wall extending between the first wall and the second wall. The bottom wall is spaced apart from the top wall along a vertical axis of the housing. The fuel tank also includes at least two first baffles disposed within the housing and extending along the vertical axis from the top wall to the bottom wall. The at least two first baffles are spaced apart from each other along the lateral axis. Each of the at least two first baffles is coupled with each of the first wall, the second wall, the first sidewall, and the second sidewall. Each of the at least two first baffles defines a plurality of through-openings proximal to the bottom wall. Each of the at least two first baffles defines at least two first cut-outs at a location where the at least two first baffles are coupled with the first wall. Each of the at least two first baffles defines at least two second cut-outs at a location where the at least two first baffles are coupled with the second wall. The fuel tank further includes at least two second baffles disposed within the housing and extending along the longitudinal axis from the first wall to the second wall. Each of the at least two second baffles intersects with each of the at least two first baffles. The at least two second baffles are spaced apart from each other along the vertical axis. Each of the at least two second baffles being coupled with each of the first wall, the second wall, the top wall, and the bottom wall. Each of the at least two second baffles defines at least two third cut-outs at a location where the at least two second baffles are coupled with the first wall. Each of the at least two second baffles defines at least two fourth cut-outs at a location where the at least two second baffles are coupled with the second wall.

In another aspect of the present disclosure, a work machine is provided. The work machine includes a frame. The work machine also includes a fuel tank removably coupled with the frame. The fuel tank includes a housing defining a first end and a second end spaced apart from the first end along a longitudinal axis of the housing. The housing includes a first wall disposed at the first end of the housing. The housing also includes a second wall disposed at the second end of the housing. The housing further includes a first sidewall extending between the first wall and the second wall. The housing includes a second sidewall extending between the first wall and the second wall. The second sidewall being spaced apart from the first sidewall along a lateral axis of the housing. The housing also includes a top wall extending between the first wall and the second wall. The housing further includes a bottom wall extending between the first wall and the second wall. The bottom wall being spaced apart from the top wall along a vertical axis of the housing. The fuel tank also includes at least two first baffles disposed within the housing and extending along the vertical axis from the top wall to the bottom wall. The at least two first baffles are spaced apart from each other along the lateral axis. Each of the at least two first baffles being coupled with each of the first wall, the second wall, the first sidewall, and the second sidewall. Each of the at least two first baffles defines a plurality of through-openings proximal to the bottom wall. Each of the at least two first baffles defines at least two first cut-outs at a location where the at least two first baffles are coupled with the first wall. Each of the at least two first baffles defines at least two second cut-outs at a location where the at least two first baffles are coupled with the second wall. The fuel tank further includes at least two second baffles disposed within the housing and extending along the longitudinal axis from the first wall to the second wall. Each of the at least two second baffles intersects with each of the at least two first baffles. The at least two second baffles are spaced apart from each other along the vertical axis. Each of the at least two second baffles is coupled with each of the first wall, the second wall, the top wall, and the bottom wall. Each of the at least two second baffles defines at least two third cut-outs at a location where the at least two second baffles are coupled with the first wall. Each of the at least two second baffles defines at least two fourth cut-outs at a location where the at least two second baffles are coupled with the second wall.

Other features and aspects of this disclosure will be apparent from the following description and the accompanying drawings.

### BRIEF DESCRIPTION OF THE DRAWINGS

FIG. 1 is a schematic side view of an exemplary work machine;

FIG. 2A is a schematic perspective view of a fuel tank of the work machine of FIG. 1, according to an example of the present disclosure;

FIG. 2B is a schematic perspective view of the fuel tank of FIG. 2A;

FIG. 3A is a schematic side view of the fuel tank of FIG. 2A;

FIG. 3B is a schematic top view of the fuel tank of FIG. 2A;

FIG. 4 is a perspective view of the fuel tank of FIG. 2A;

FIG. 5A is a perspective view of a portion illustrating first baffles and a second baffle of the fuel tank of FIG. 2A;

FIG. 5B is a schematic perspective view of a portion of the fuel tank of FIG. 2A illustrating intersection of a first baffle and a second baffle;

FIG. 5C is a schematic perspective view of a portion of the fuel tank of FIG. 2A illustrating intersection of the first baffle and the second baffle;

FIG. 6 is a schematic perspective view of a portion of the fuel tank of FIG. 2A;

FIG. 7 is a perspective view of a portion illustrating chamfers in the second baffle of the fuel tank of FIG. 2A, according to an example of the present disclosure; and

FIG. 8 is a perspective view of a portion illustrating cutouts in a second baffle that may be associated with the fuel tank of FIG. 2A, according to another example of the present disclosure;

### DETAILED DESCRIPTION

Wherever possible, the same reference numbers will be used throughout the drawings to refer to the same or like parts.

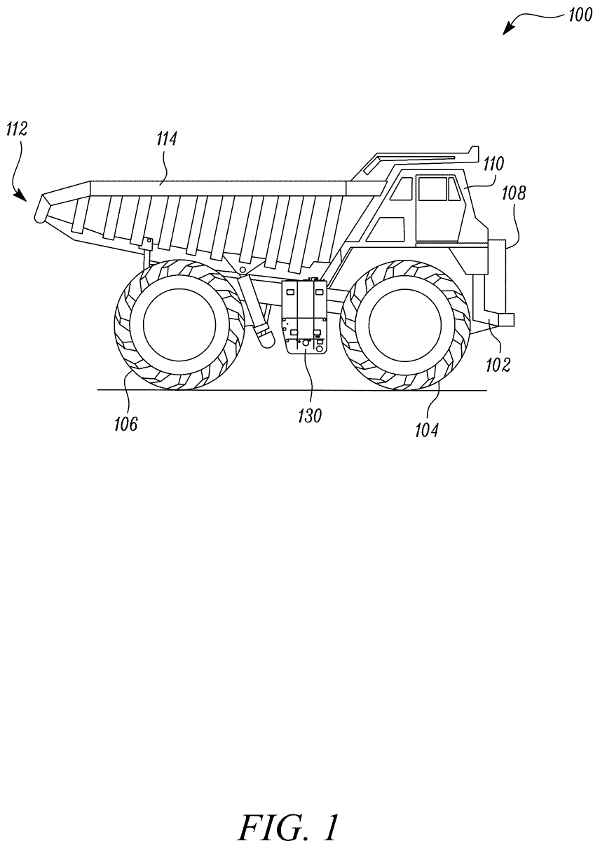

Referring to FIG. 1, a schematic side view of an exemplary work machine 100 is illustrated. The work machine 100 is embodied as a mining truck that may be used to move payloads, such as asphalt, debris, dirt, snow, feed, gravel, logs, raw minerals, recycled material, rock, sand, woodchips, etc. from one location to another location. Alternatively, the work machine 100 may be a hydraulic excavator, a dozer, a wheel loader, a track-type tractor, a motor grader, etc. that may be used for various purposes, such as digging, construction, landscaping, and the like in various industries. It should be noted that the work machine 100 may include any other stationary or movable work machine known in the art that requires a fuel tank. The work machine 100 may be manual, autonomous, or semi-autonomous.

The work machine 100 includes a frame 102. The frame 102 supports a pair of front wheels 104 and a pair of rear wheels 106 of the work machine 100 (only one of each of the pair of front wheels 104 and the pair of rear wheels 106 is shown for illustrative purposes). The work machine 100 also includes an enclosure 108. The enclosure 108 may house a power source (not shown), such as an engine (for e.g., an internal combustion engine), a battery system, motors, a fuel cell, and the like to provide power to various components of the work machine 100 for operational and mobility requirements.

The work machine 100 further includes a dump body 112. The dump body 112 includes a box portion 114. The box portion 114 of the dump body 112 may hold the payload. The dump body 112 is movable relative to the frame 102. Further, when the work machine 100 is of another type, such as, the track type tractor, the excavator, the bulldozer, the motor grader, the work machine 100 includes one or more implement assemblies instead of the dump body 112. Such implement assemblies may include an implement, such as a bucket, blade, ripper, one or more linkages, and one or more hydraulic actuators to move the implement and the linkages.

The work machine 100 also includes an operator cabin 110 mounted to the frame 102. The operator cabin 110 may include one or more controls (not shown) that may enable the operator to control the work machine 100. The operator may be seated within the operator cabin 110 to perform work operations.

The work machine 100 further includes a fuel tank 130 removably coupled with the frame 102. The fuel tank 130 is used for storing and supplying a fuel to the power source, ensuring the work machine 100 operates efficiently for extended periods. In the illustrated example of FIG. 1, the fuel tank 130 is cuboidal in shape. In some examples, the fuel tank 130 may be square in shape, or may have any other shape, without any limitations.

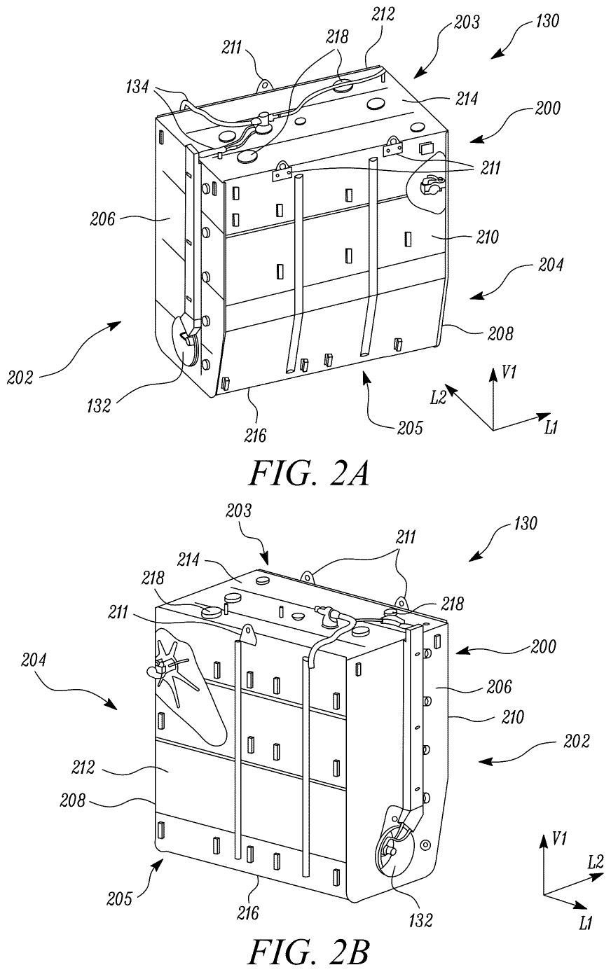

Referring to FIGS. 2A and 2B, schematic perspective views of the fuel tank 130 of the work machine 100 (see FIG. 1) is illustrated. The fuel tank 130 includes a housing 200. The housing 200 defines a first end 202 and a second end 204 spaced apart from the first end 202 along a longitudinal axis L1 of the housing 200. The housing 200 also defines a top end 203 and a bottom end 205 spaced apart from the top end 203 along a vertical axis V1 of the housing 200. The fuel tank 130 includes a fuel pump 132 to pump the fuel from the fuel tank 130 to the power source via a fuel pipe assembly 134. The fuel pump 132 is supported on the housing 200. The fuel tank 130 also includes a fuel pressor sensor (not shown) to monitor a pressure of the fuel within the fuel tank 130 and the fuel pipe assembly 134 and/or a fuel level sensor (not shown) to monitor a level of the fuel within the fuel tank 130.

The housing 200 includes a first wall 206 disposed at the first end 202 of the housing 200. The housing 200 also includes a second wall 208 disposed at the second end 204 of the housing 200. Generally, the first wall 206 is a front wall of the housing 200 and the second wall 208 is a rear wall of the housing 200. The fuel pump 132 is coupled with the first wall 206 of the housing 200 herein.

The housing 200 further includes a first sidewall 210 extending between the first wall 206 and the second wall 208. The housing 200 also includes one or more coupling members 211 to couple the fuel tank 130 with the frame 102 of the work machine 100. In the illustrated example of FIGS. 2A and 2B, the one or more coupling members 211 are three coupling members 211. Specifically, two coupling members 211 are disposed on the first sidewall 210 of the housing 200, and one coupling member 211 is disposed on a second sidewall 212 of the housing 200.

The housing 200 further includes the second sidewall 212 extending between the first wall 206 and the second wall 208. The second sidewall 212 is spaced apart from the first sidewall 210 along a lateral axis L2 of the housing 200.

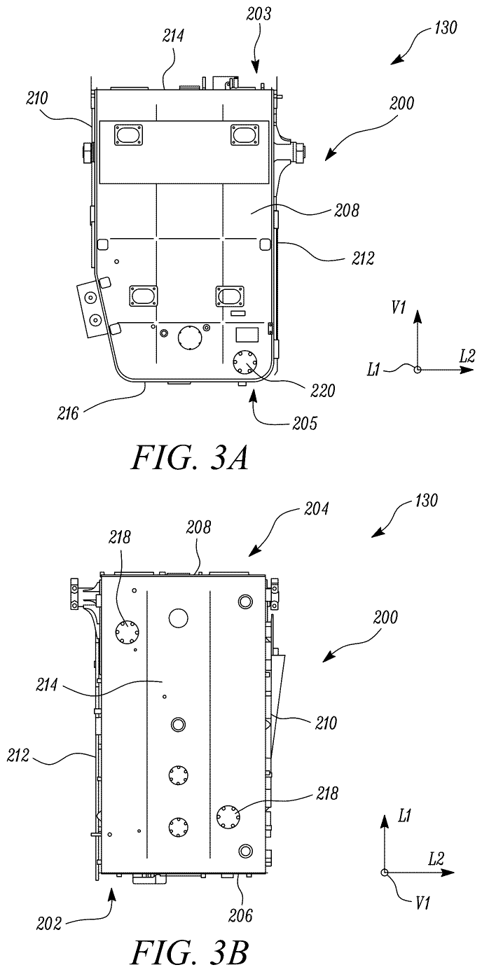

Referring now to FIG. 3A, the first wall 206 (see FIGS. 2A and 2B) and/or the second wall 208 defines one or more fluid outlet ports 220. In the illustrated example of FIG. 3A, the second wall 208 defines a single fluid outlet port 220. However, the second wall 208 may define more than one fluid outlet port 220. Further, the fluid outlet port 220 is disposed proximal to the bottom end 205 of the housing 200. A cleaning fluid exits the housing 200 via the one or more fluid outlet ports 220. Alternatively, the first wall 206 may define the one or more fluid outlet ports 220.

With reference to FIGS. 2A, 2B, and 3B, the housing 200 further includes a top wall 214 extending between the first wall 206 and the second wall 208. The top wall 214 is disposed at the top end 203 of the housing 200. The top wall 214 of the housing 200 defines one or more fluid inlet ports 218. As shown in FIG. 3B, the top wall 214 defines two fluid inlet ports 218. The two fluid inlet ports 218 are diagonally spaced apart from each other. The cleaning fluid is receivable within the housing 200 via the one or more fluid inlet ports 218.

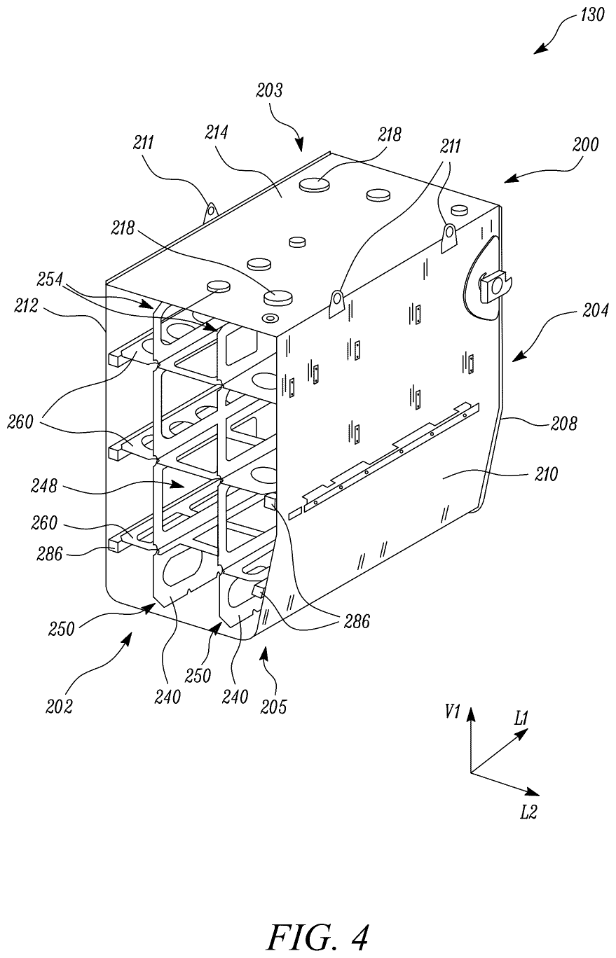

Referring now to FIG. 4, a perspective view of the fuel tank 130 is illustrated. The first wall 206 (see FIGS. 2A and 2B) is omitted from the view in FIG. 4. The housing 200 further includes a bottom wall 216 extending between the first wall 206 and the second wall 208. The bottom wall 216 is spaced apart from the top wall 214 along the vertical axis V1 of the housing 200. The bottom wall 216 is disposed at the bottom end 205 of the housing 200.

The fuel tank 130 also includes two or more first baffles 240 disposed within the housing 200 and extending along the vertical axis V1 from the top wall 214 to the bottom wall 216. In the illustrated example of FIG. 4, the two or more first baffles 240 are two first baffles 240. In some examples, the two or more first baffles 240 may include three first baffles 240, four first baffles 240, and the like, without limiting the scope of the present disclosure. A number of the first baffles 240 may increase, for example, based on a size of the fuel tank 130.

The two or more first baffles 240 are spaced apart from each other along the lateral axis L2. Each of the two or more first baffles 240 are coupled with each of the first wall 206, the second wall 208, the top wall 214, and the bottom wall 216. In some examples, the two or more first baffles 240 may be coupled with each of the first wall 206, the second wall 208, the top wall 214, and the bottom wall 216 by welding, soldering, brazing, and the like without any limitations. Each of the two or more first baffles 240 includes a number of through-holes 248 that are spaced apart from each other along the vertical axis V1 and the longitudinal axis L1.

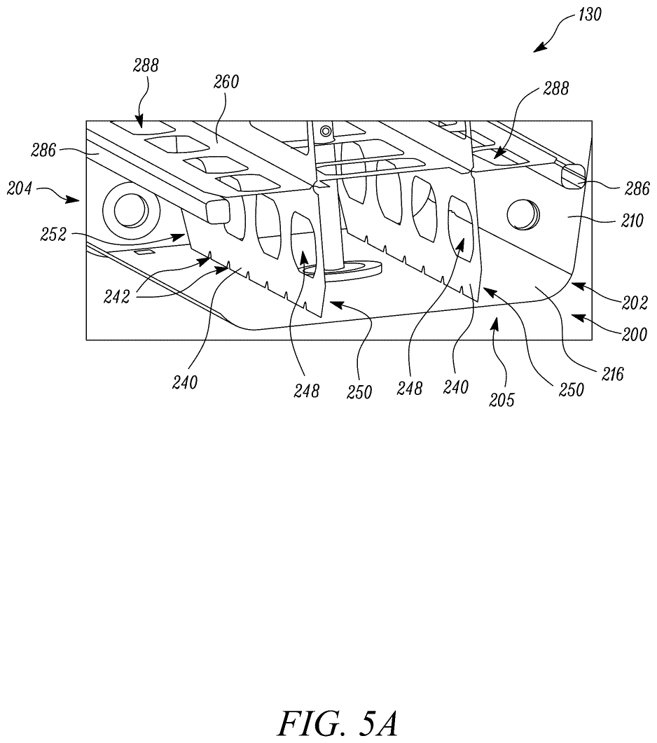

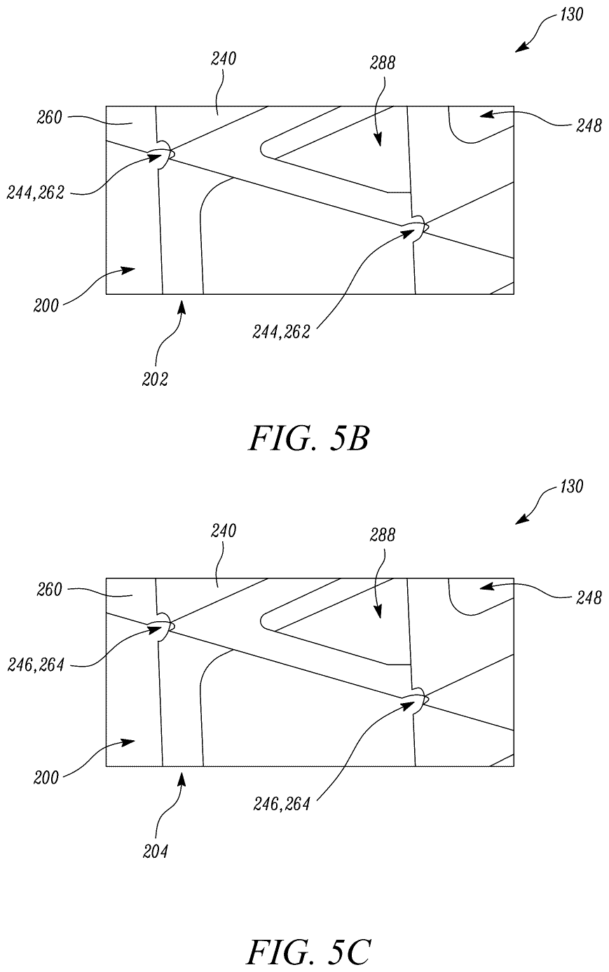

Referring to FIG. 5A, a perspective view of a portion of the fuel tank 130 is illustrated. The first wall 206 (see FIGS. 2A and 2B) is omitted from the view in FIG. 5A. Each of the two or more first baffles 240 defines a number of through-openings 242 proximal to the bottom wall 216. In the illustrated example of FIG. 5A, the number of through-openings 242 are six through-openings 242. In some examples, the number of through-openings 242 may be five through-openings 242, seven through-openings 242, eight through-openings 242, and the like, without limiting the scope of the present disclosure. In the illustrated example of FIG. 5A, each through-opening 242 is semi-circular in shape. In some examples, the number of through-openings 242 may be rectangular in shape, square in shape, elliptical in shape, conical in shape, and the like, without any limitations. Further, the number of through-openings 242 may have a diameter in a range of 20 millimeter (mm) to 60 mm, as an example.

In the illustrated example of FIG. 5A, the number of through-openings 242 in each of the two or more first baffles 240 are equidistantly spaced apart from each other along the longitudinal axis L1. In other examples, the number of through-openings 242 in each of the two or more first baffles 240 may be disposed at arbitrary distances from each other along the longitudinal axis L1, without any limitations.

Furthermore, each of the two or more first baffles 240 defines a fifth chamfer 250 proximal to the first end 202 of the housing 200. The fifth chamfer 250 is defined at a location where a corresponding first baffle 240 from the two or more first baffles 240 is coupled with the bottom wall 216.

Each of the two or more first baffles 240 also defines a sixth chamfer 252 proximal to the second end 204 of the housing 200. The sixth chamfer 252 is defined at a location where a corresponding first baffle 240 from the two or more first baffles 240 is coupled with the bottom wall 216.

Each of the two or more first baffles 240 further defines a seventh chamfer 254 (shown in FIG. 4) proximal to the first end 202 of the housing 200. The seventh chamfer 254 is defined at a location where a corresponding first baffle 240 from the two or more first baffles 240 is coupled with the top wall 214.

Moreover, each of the two or more first baffles 240 defines an eighth chamfer (not shown) proximal to the second end 204 of the housing 200. The eighth chamfer is defined at a location where a corresponding first baffle 240 from the two or more first baffles 240 is coupled with the top wall 214.

With reference to FIG. 5B, each of the two or more first baffles 240 defines two or more first cut-outs 244 at a location where the two or more first baffles 240 are coupled with the first wall 206. In the illustrated example of FIG. 5B, the two or more first cut-outs 244 include three first cut-outs 244. The two or more first cut-outs 244 in each of the two or more first baffles 240 is defined at an intersection of the two or more first baffles 240 with a corresponding second baffle 260 from two or more second baffles 260 of the housing 200. Generally, a total number of the first cut-outs 244 is equal to a total number of the second baffles 260 associated with the housing 200.

FIG. 5C is a schematic perspective view of a portion of the fuel tank 130 illustrating the intersection of the first baffle 240 and the second baffle 260. The second wall 208 (see FIGS. 2A and 2B) is omitted from the view in FIG. 5C.

As shown in FIG. 5C, each of the two or more first baffles 240 also defines two or more second cut-outs 246 at a location where the two or more first baffles 240 are coupled with the second wall 208. The two or more second cut-outs 246 include three second cut-outs 246. The two or more second cut-outs 246 in each of the two or more first baffles 240 is defined at the intersection of the two or more first baffles 240 with the corresponding second baffle 260 from the two or more second baffles 260 of the housing 200. Generally, a total number of the second cut-outs 246 is equal to the total number of the second baffles 260 associated with the housing 200.

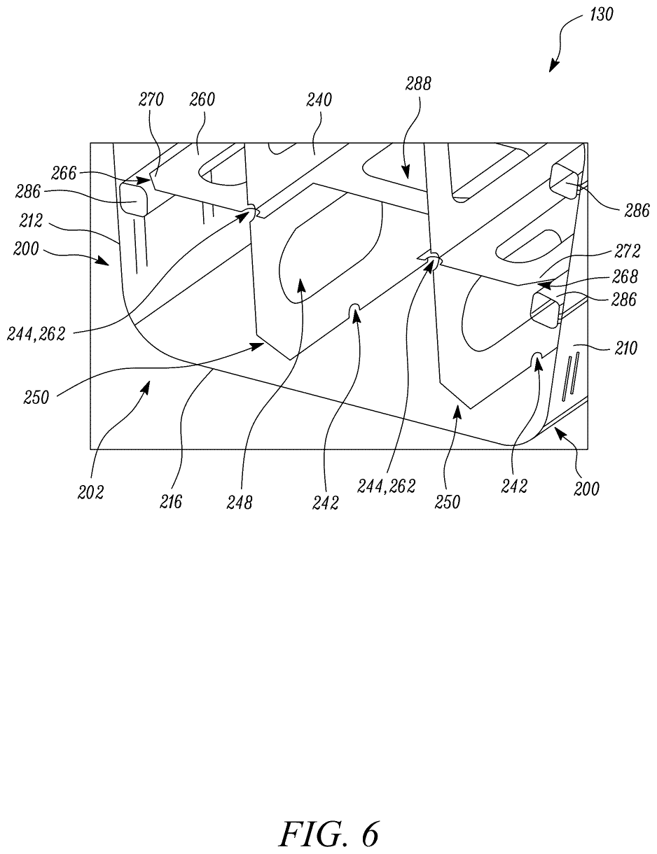

With reference to FIGS. 4 and 6, the fuel tank 130 further includes the two or more second baffles 260 disposed within the housing 200 and extending along the longitudinal axis L1 from the first wall 206 (see FIGS. 2A and 2B) to the second wall 208. The two or more second baffles 260 are spaced apart from each other along the vertical axis V1. In the illustrated example of FIGS. 4 and 6, the two or more second baffles 260 include three second baffles 260. In some examples, the two or more second baffles 260 may include two second baffles 260, four second baffles 260, and the like, without any limitations. Each of the two and more second baffles 260 intersects with each of the two or more first baffles 240.

Each of the two or more second baffles 260 is coupled with each of the first wall 206, the second wall 208, the first sidewall 210, and the second sidewall 212. Each second baffle 260 is coupled with the first sidewall 210 and the second sidewall 212 via a corresponding coupling rod 286. Each second baffle 260 is coupled with a corresponding coupling rod 286 by welding, soldering, brazing, and the like. Each coupling rod 286 is in turn coupled with the first sidewall 210 and the second sidewall 212 by welding, soldering, brazing, and the like. Each of the two or more second baffles 260 includes a number of through-holes 288 that are spaced apart from each other along the lateral axis L2 and the longitudinal axis L1.

Further, the housing 200 also includes the number of coupling rods 286 coupled with the first sidewall 210 and the second sidewall 212 and extending along the longitudinal axis L1. Furthermore, a total number of the coupling rods 286 is twice the total number of the second baffles 260, accordingly, the housing 200 includes six coupling rods 286.

Each of the two or more second baffles 260 defines two or more third cut-outs 262 at a location where the two or more second baffles 260 are coupled with the first wall 206. As shown in FIG. 6, the two or more third cut-outs 262 include two third cut-outs 262. The two or more third cut-outs 262 in each of the two or more second baffles 260 is defined at an intersection of the two or more second baffles 260 with a corresponding first baffle 240.

Referring now to FIG. 5C, each of the two or more second baffles 260 defines two or more fourth cut-outs 264 at a location where the two or more second baffles 260 are coupled with the second wall 208 (shown in FIGS. 2A and 2B). As shown in FIG. 5C, the two or more fourth cut-outs 264 include two fourth cut-outs 264. The two or more fourth cut-outs 264 in each of the two or more second baffles 260 is defined at the intersection of the two or more second baffles 260 with the corresponding first baffle 240.

Referring to FIGS. 5B, 5C, and 6, each of the two or more first cut-outs 244, the two or more second cut-outs 246, the two or more third cut-outs 262, and the two or more fourth cut-outs 264 is semi-circular in shape. In some examples, each of the two or more first cut-outs 244, the two or more second cut-outs 246, the two or more third cut-outs 262, and the two or more fourth cut-outs 264 may be rectangular in shape, square in shape, elliptical in shape, conical in shape, and the like without any limitations. Further, each of the two or more first cut-outs 244, the two or more second cut-outs 246, the two or more third cut-outs 262, and the two or more fourth cut-outs 264 may have a diameter in a range of 20 mm to 60 mm, as an example.

Referring now to FIG. 6, each of the two or more second baffles 260 defines a first chamfer 266 and a second chamfer 268 proximal to the first end 202 of the housing 200. The first chamfer 266 is defined at a first corner 270 of the corresponding second baffle 260 from the two or more second baffles 260 and the second chamfer 268 is defined at a second corner 272 of the corresponding second baffle 260 from the two or more second baffles 260. The second corner 272 is disposed opposite to the first corner 270 relative to the lateral axis L2.

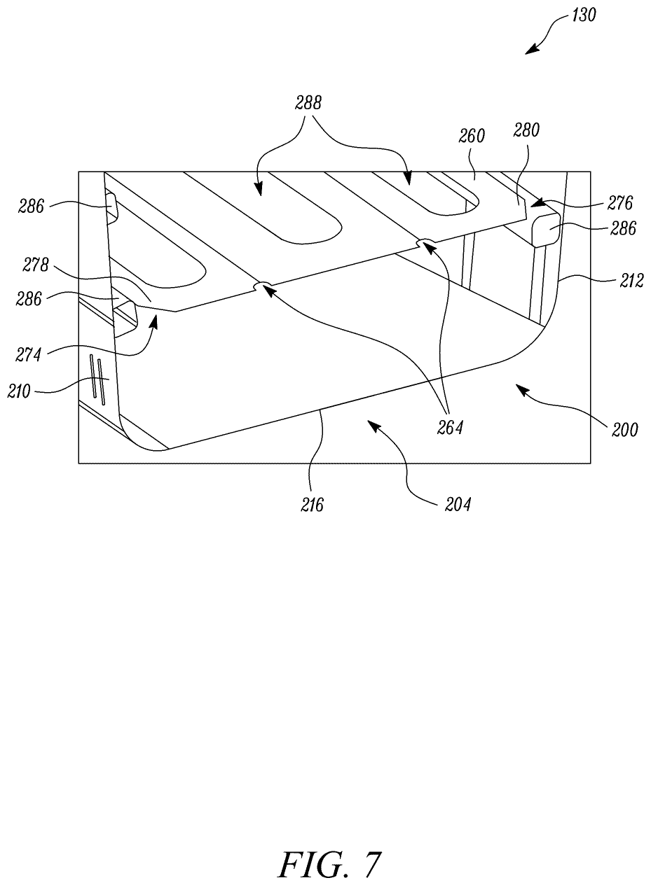

Referring now to FIG. 7, each of the two or more second baffles 260 defines a third chamfer 274 and a fourth chamfer 276 proximal to the second end 204 of the housing 200. The third chamfer 274 is defined at a third corner 278 of the corresponding second baffle 260 from the two or more second baffles 260. Further, the fourth chamfer 276 is defined at a fourth corner 280 of the corresponding second baffle 260 from the two or more second baffles 260. The fourth corner 280 is disposed opposite to the third corner 278 relative to the lateral axis L2.

Further, each of the first chamfer 266 (see FIG. 6), the second chamfer 268 (see FIG. 6), the third chamfer 274, and the fourth chamfer 276 has a size that may lie in a range of 20×20 mm to 70×70 mm, as an example.

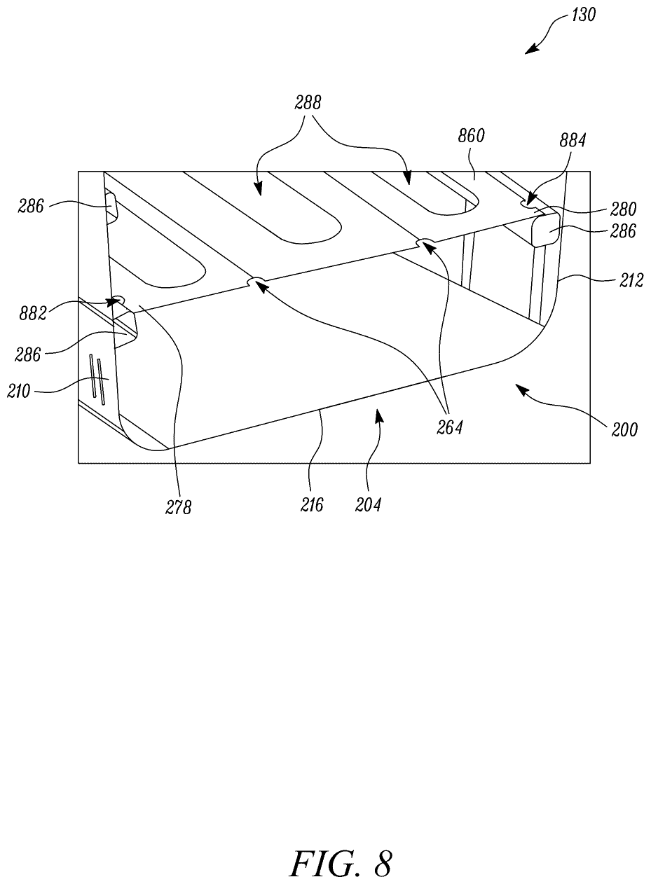

FIG. 8 illustrates another design for a second baffle 860 associated with the fuel tank 130. In the illustrated example of FIG. 8, each of two or more second baffles 860 defines a fifth cut-out 882 and a sixth cut-out 884 proximal to the second end 204 of the housing 200. Specifically, the fifth cut-out 882 and the sixth cut-out 884 is defined in the second baffle 860 that is closest to the bottom wall 216 of the housing 200.

The fifth cut-out 882 is defined at a location where a corresponding second baffle 860 from the two or more second baffles 860 is coupled with the first sidewall 210. Specifically, the fifth cut-out 882 is defined near to the third corner 278 of the corresponding second baffle 860 from the two or more second baffles 860.

Further, the sixth cut-out 884 is defined at a location where a corresponding second baffle 860 from the two or more second baffles 860 is coupled with the second sidewall 212. Specifically, the sixth cut-out 884 is defined proximal to the fourth corner 280 of the corresponding second baffle 860 from the two or more second baffles 860. Each of the fifth cut-out 882 and the sixth cut-out 884 is semi-circular in shape. In some examples, the fifth cut-out 882 and the sixth cut-out 884 may be square in shape, rectangular in shape, elliptical in shape, conical in shape, and the like, without any limitations.

Further, the fifth cut-out 882 and the sixth cut-out 884 may have a diameter in a range of 20 mm to 60 mm, as an example. In some examples, each of the fifth cut-out 882 and the sixth cut-out 884 is spaced apart from the second end 204 of the housing 200 by a distance that lies in a range of 15 mm to 35 mm, as an example. It should be noted that the third chamfer 274 (see FIG. 7) and the fourth chamfer 276 (see FIG. 7) present in the second baffle 260 (see FIG. 7) that is closest to the bottom wall 216 (see FIG. 6) is replaced by the fifth cut-out 882 and the sixth cut-out 884.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the fuel tank 130 including the housing 200. The fuel tank 130 includes the first baffles 240 and the second baffles 260, 860. Each of the two or more first baffles 240 defines the number of through-openings 242, the fifth chamfer 250, the sixth chamfer 252, the seventh chamfer 254, the eighth chamfer, the two or more first cut-outs 244, and the two or more second cut-outs 246. Further, each of the two or more second baffles 260, 860 defines the two or more third cut-outs 262, the two or more fourth cut-outs 264, the first chamfer 266, and the second chamfer 268. In some examples, the second baffles 260 includes the third chamfer 274 and the fourth chamfer 276 proximal to the second end 204 of the housing 200. In other examples, the second baffle 860 includes the fifth cut-out 882 and the sixth cut-out 884 proximal to the second end 204 of the housing 200.

During a cleaning operation of the fuel tank 130, the cleaning fluid may enter the housing 200 at high pressure via the fluid inlet ports 218. Further, the through-openings 242, the fifth chamfer 250, the sixth chamfer 252, the seventh chamfer 254, the eighth chamfer, the first cut-outs 244, the second cut-outs 246, the third cut-outs 262, the fourth cut-outs 264, the first chamfer 266, the second chamfer 268, the third chamfer 274, the fourth chamfer 276, the fifth cut-out 882, and the sixth cut-out 884 may allow easy passage of sediments such as, dirt, dust, grains, bits, specks, fragments, crumbs, and the like as well as water during a cleaning operation of the fuel tank 130, may prevent an accumulation of sediments as well as water at edges or corners of the first baffles 240 during the cleaning operation of the fuel tank 130, and may allow effective cleaning of the fuel tank 130. Further, after the cleaning operation, the fuel tank 130 may be tilted to allow the cleaning fluid to exit the housing 200 via the fluid outlet port 220.

A design of the first and second baffles 240, 260, 860 as described herein may improve a cleanliness of the fuel tank 130, and may prevent mixing of sediments with fuel that is later received within the fuel tank 130. Overall, the fuel tank 130 including the first baffles 240 and the second baffles 260, 860 described herein may be simple in construction, may be cost-effective, and may be durable. Further, the fuel tank 130 described herein may be retrofitted on existing work machines.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A fuel tank for a work machine, the fuel tank comprising:
a housing defining a first end and a second end spaced apart from the first end along a longitudinal axis of the housing, the housing including:
a first wall disposed at the first end of the housing;
a second wall disposed at the second end of the housing;
a first sidewall extending between the first wall and the second wall;
a second sidewall extending between the first wall and the second wall, the second sidewall being spaced apart from the first sidewall along a lateral axis of the housing;
a top wall extending between the first wall and the second wall; and
a bottom wall extending between the first wall and the second wall, the bottom wall being spaced apart from the top wall along a vertical axis of the housing;
at least two first baffles disposed within the housing and extending along the vertical axis from the top wall to the bottom wall, the at least two first baffles being spaced apart from each other along the lateral axis, each of the at least two first baffles being coupled with each of the first wall, the second wall, the first sidewall, and the second sidewall, wherein each of the at least two first baffles defines a plurality of through-openings proximal to the bottom wall, wherein each of the at least two first baffles defines at least two first cut-outs at a location where the at least two first baffles are coupled with the first wall, and wherein each of the at least two first baffles defines at least two second cut-outs at a location where the at least two first baffles are coupled with the second wall; and
at least two second baffles disposed within the housing and extending along the longitudinal axis from the first wall to the second wall, each of the at least two second baffles intersecting with each of the at least two first baffles, the at least two second baffles being spaced apart from each other along the vertical axis, each of the at least two second baffles being coupled with each of the first wall, the second wall, the top wall, and the bottom wall, wherein each of the at least two second baffles defines at least two third cut-outs at a location where the at least two second baffles are coupled with the first wall, and wherein each of the at least two second baffles defines at least two fourth cut-outs at a location where the at least two second baffles are coupled with the second wall.

2. The fuel tank of claim 1, wherein the at least two first cut-outs in each of the at least two first baffles is defined at an intersection of the at least two first baffles with a corresponding second baffle, and wherein the at least two second cut-outs in each of the at least two first baffles is defined at an intersection of the at least two first baffles with a corresponding second baffle.

3. The fuel tank of claim 1, wherein the at least two third cut-outs in each of the at least two second baffles is defined at an intersection of the at least two second baffles with a corresponding first baffle, and wherein the at least two fourth cut-outs in each of the at least two second baffles is defined at an intersection of the at least two second baffles with a corresponding first baffle.

4. The fuel tank of claim 1, wherein the plurality of through-openings in each of the at least two first baffles are equidistantly spaced apart from each other along the longitudinal axis.

5. The fuel tank of claim 1, wherein the top wall of the housing defines at least one fluid inlet port, and wherein a cleaning fluid is receivable within the housing via the at least one fluid inlet port.

6. The fuel tank of claim 5, wherein at least one of the first wall and the second wall define at least one fluid outlet port, and wherein the cleaning fluid exits the housing via the at least one fluid outlet port.

7. The fuel tank of claim 1, wherein each of the at least two second baffles defines a first chamfer and a second chamfer proximal to the first end of the housing, wherein the first chamfer is defined at a first corner of a corresponding second baffle from the at least two second baffles and the second chamfer is defined at a second corner of a corresponding second baffle from the at least two second baffles, and wherein the second corner is disposed opposite to the first corner relative to the lateral axis.

8. The fuel tank of claim 1, wherein each of the at least two second baffles defines a third chamfer and a fourth chamfer proximal to the second end of the housing, wherein the third chamfer is defined at a third corner of a corresponding second baffle from the at least two second baffles and the fourth chamfer is defined at a fourth corner of a corresponding second baffle from the at least two second baffles, and wherein the fourth corner is disposed opposite to the third corner relative to the lateral axis.

9. The fuel tank of claim 1, wherein each of the at least two second baffles defines a fifth cut-out and a sixth cut-out proximal to the second end of the housing, wherein the fifth cut-out is defined at a location where a corresponding second baffle from the at least two second baffles is coupled with the first sidewall and the sixth cut-out is defined at a location where a corresponding second baffle from the at least two second baffles is coupled with the second sidewall, and wherein each of the fifth cut-out and the sixth cut-out is semi-circular in shape.

10. The fuel tank of claim 1, wherein each of the at least two first cut-outs, the at least two second cut-outs, the at least two third cut-outs, and the at least two fourth cut-outs is semi-circular in shape.

11. The fuel tank of claim 1, wherein each of the at least two first baffles defines:
a fifth chamfer proximal to the first end of the housing, wherein the fifth chamfer is defined at a location where a corresponding first baffle from the at least two first baffles is coupled with the bottom wall;
a sixth chamfer proximal to the second end of the housing, wherein the sixth chamfer is defined at a location where a corresponding first baffle from the at least two first baffles is coupled with the bottom wall; a seventh chamfer proximal to the first end of the housing, wherein the seventh chamfer is defined at a location where a corresponding first baffle from the at least two first baffles is coupled with the top wall; and
an eighth chamfer proximal to the second end of the housing, wherein the eighth chamfer is defined at a location where a corresponding first baffle from the at least two first baffles is coupled with the top wall.

12. A work machine comprising:
a frame; and
a fuel tank removably coupled with the frame, the fuel tank including:
a housing defining a first end and a second end spaced apart from the first end along a longitudinal axis of the housing, the housing including:
a first wall disposed at the first end of the housing;
a second wall disposed at the second end of the housing;
a first sidewall extending between the first wall and the second wall;
a second sidewall extending between the first wall and the second wall, the second sidewall being spaced apart from the first sidewall along a lateral axis of the housing;
a top wall extending between the first wall and the second wall; and
a bottom wall extending between the first wall and the second wall, the bottom wall being spaced apart from the top wall along a vertical axis of the housing;
at least two first baffles disposed within the housing and extending along the vertical axis from the top wall to the bottom wall, the at least two first baffles spaced apart from each other along the lateral axis, each of the at least two first baffles being coupled with each of the first wall, the second wall, the first sidewall, and the second sidewall, wherein each of the at least two first baffles defines a plurality of through-openings proximal to the bottom wall, wherein each of the at least two first baffles defines at least two first cut-outs at a location where the at least two first baffles are coupled with the first wall, and wherein each of the at least two first baffles defines at least two second cut-outs at a location where the at least two first baffles are coupled with the second wall; and
at least two second baffles disposed within the housing and extending along the longitudinal axis from the first wall to the second wall, each of the at least two second baffles intersecting with each of the at least two first baffles, the at least two second baffles being spaced apart from each other along the vertical axis, each of the at least two second baffles being coupled with each of the first wall, the second wall, the top wall, and the bottom wall, wherein each of the at least two second baffles defines at least two third cut-outs at a location where the at least two second baffles are coupled with the first wall, and wherein each of the at least two second baffles defines at least two fourth cut-outs at a location where the at least two second baffles are coupled with the second wall.

13. The work machine of claim 12, wherein the at least two first cut-outs in each of the at least two first baffles is defined at an intersection of the at least two first baffles with a corresponding second baffle, and wherein the at least two second cut-outs in each of the at least two first baffles is defined at an intersection of the at least two first baffles with a corresponding second baffle.

14. The work machine of claim 12, wherein the at least two third cut-outs in each of the at least two second baffles is defined at an intersection of the at least two second baffles with a corresponding first baffle, and wherein the at least two fourth cut-outs in each of the at least two second baffles is defined at an intersection of the at least two second baffles with a corresponding first baffle.

15. The work machine of claim 12, wherein the top wall of the housing defines at least one fluid inlet port, and wherein a cleaning fluid is receivable within the housing via the at least one fluid inlet port.

16. The work machine of claim 15, wherein at least one of the first wall and the second wall define at least one fluid outlet port, and wherein the cleaning fluid exits the housing via the at least one fluid outlet port.

17. The work machine of claim 12, wherein each of the at least two second baffles defines a first chamfer and a second chamfer proximal to the first end of the housing, wherein the first chamfer is defined at a first corner of a corresponding second baffle from the at least two second baffles and the second chamfer is defined at a second corner of a corresponding second baffle from the at least two second baffles, and wherein the second corner is disposed opposite to the first corner relative to the lateral axis.

18. The work machine of claim 12, wherein each of the at least two second baffles defines a third chamfer and a fourth chamfer proximal to the second end of the housing, wherein the third chamfer is defined at a third corner of a corresponding second baffle from the at least two second baffles and the fourth chamfer is defined at a fourth corner of a corresponding second baffle from the at least two second baffles, and wherein the fourth corner is disposed opposite to the third corner relative to the lateral axis.

19. The work machine of claim 12, wherein each of the at least two second baffles defines a fifth cut-out and a sixth cut-out proximal to the second end of the housing, wherein the fifth cut-out is defined at a location where a corresponding second baffle from the at least two second baffles is coupled with the first sidewall and the sixth cut-out is defined at a location where a corresponding second baffle from the at least two second baffles is coupled with the second sidewall, and wherein each of the fifth cut-out and the sixth cut-out is semi-circular in shape.

20. The work machine of claim 12, wherein each of the at least two first baffles defines:
a fifth chamfer proximal to the first end of the housing, wherein the fifth chamfer is defined at a location where a corresponding first baffle from the at least two first baffles is coupled with the bottom wall;
a sixth chamfer proximal to the second end of the housing, wherein the sixth chamfer is defined at a location where a corresponding first baffle from the at least two first baffles is coupled with the bottom wall;
a seventh chamfer proximal to the first end of the housing, wherein the seventh chamfer is defined at a location where a corresponding first baffle from the at least two first baffles is coupled with the top wall; and
an eighth chamfer proximal to the second end of the housing, wherein the eighth chamfer is defined at a location where a corresponding first baffle from the at least two first baffles is coupled with the top wall.
